(19) United States
(12) Patent Application Publication
(10) Pub. No.: US 2010/0125481 A1
(43) Pub. Date: May 20, 2010

(54) SYSTEM AND METHOD FOR PROVIDING INVESTMENT PRODUCTS

(75) Inventors: John F. Kennedy, Simsbury, CT (US); Stephen E. Abbey, Marlborough, CT (US); Diana K. Benken, Hebron, CT (US); Richard E. Cady, Simsbury, CT (US); Jennifer Anne Como, San Francisco, CA (US); William D. Wilcox, West Hartford, CT (US)

Correspondence Address: ROPES & GRAY LLP, PATENT DOCKETING 39/41, ONE INTERNATIONAL PLACE, BOSTON, MA, 02110-2624, US

(73) Assignee: Hartford Fire Insurance Company, Hartford, CT (US)

(21) Appl. No.: 12/273,263

(22) Filed: Nov. 18, 2008

(51) Int. Cl. G06Q 40/00

(52) U.S. Cl. 705/8; 705/39

(57) ABSTRACT

The invention relates, in various aspects, to systems, methods, and computer readable media suited for enabling partial owners of wholesale broker dealers to participate in providing investment products. Reports of wholesale fees received by and expenses incurred by a wholesale broker-dealer, in relation to wholesale support services for investment products, are stored. The wholesale support services are provided to registered representatives of a separate retail broker-dealer who are affiliated with the partial owners. The wholesale fees and expenses are allocated among the partial owners. A distribution is determined and effected for each partial owner based on a difference between the wholesale fees and the expenses allocated to the respective partial owner.

### BACKGROUND OF THE INVENTION

Customers often prefer to have one provider for both their insurance and investment needs. Property and casualty insurance agencies often lack the expertise and other prerequisites, such as necessary licensing, to provide their customers with investment products such as retirement plans, life insurance, annuities, or mutual funds. As such, many customers who need property and casualty insurance coverage, such as small or mid-sized business owners, often do not take advantage of investment products for their businesses. Consolidating the provision of insurance and investment products into one entity would not only reduce complexity for a customer, but also allow the customer to rely and capitalize on the pre-existing relationship and trust already built between the entity and customer

### SUMMARY OF THE INVENTION

A need exists in the art for systems and methods that would allow such insurance providers, and more generally any provider of business services, to partially own interests in a structured wholesale broker dealer that in turn provides for effective expansion of the investment product services they may offer to their customers and the access by their customers to financial products.

Accordingly, in one aspect, the invention relates to a data processing system for enabling partial owners of a wholesale broker dealer (“partial owners”) to participate in providing investment products. The data processing system includes a computer memory and a computer processor operated by the wholesale broker-dealer. The memory stores data, e.g., in the form of electronic data files, indicative of wholesale fees and data indicative of expenses. The wholesale fees are received by the wholesale broker-dealer for providing the wholesale support services to registered representatives of a separate retail broker-dealer who are affiliated with the partial owners. The wholesale fees are received in relation to sales of the investment products by the retail broker dealer. The expenses are incurred by the wholesale broker-dealer in relation to providing the wholesale support services. The computer processor is configured to, on a recurring basis, allocate the wholesale fees and the expenses among the partial owners, determine a distribution for each of a plurality of the partial owners based on a difference between the wholesale fees and the expenses allocated to the respective partial owners, and effect the distributions. The distribution for each partial owner may be either a profit for receipt by the respective partial owner or a loss to be paid by the respective partial owner to the wholesale broker-dealer. A distribution may be effected by disbursing a payment for receipt by a partial owner.

In some embodiments, at least a plurality of the partial owners are non-broker dealers. In some embodiments, an underwriting broker-dealer or an affiliate thereof owns an interest in the wholesale broker-dealer.

In some embodiments, the wholesale fees and/or the expenses allocated to each partial owner depend in part on the wholesale support services received by registered representatives affiliated with the respective partial owners.

In some embodiments, the processor is further configured to, on a recurring basis, generate and output reports that include at least one of the determined distributions to the partial owners.

According to another aspect, the invention relates to a computerized method for enabling partial owners of a wholesale broker-dealer to participate in providing investment products. The computerized method includes storing, by a wholesale broker dealer computer system in computer memory, data indicative of wholesale fees and storing data indicative of expenses. The wholesale fees are received by a wholesale broker-dealer for providing the wholesale support services to registered representatives of a separate retail broker-dealer who are affiliated with the partial owners. The fees are related to sales of investment products made by the retail broker dealer. The expenses are incurred by the wholesale broker-dealer in relation to providing the wholesale support services. The computerized method further includes allocating, by the wholesale broker-dealer computer system on a recurring basis, the wholesale fees and the expenses among at least a plurality of the partial owners, determining a distribution for a plurality of the partial owners based on a difference between the wholesale fees and the expenses allocated to the respective partial owners, and effecting the distributions.

According to another aspect, the invention relates to a system for enabling partial owners of a wholesale broker dealer to participate in providing investment products. The system includes computer processors operated by an underwriting broker-dealer, a wholesale broker-dealer, a retail broker-dealer, and the partial owners. The computer processor operated by the underwriting broker-dealer is configured for disbursing payments of wholesale fees to the wholesale broker-dealer and disbursing payments of commissions to the retail broker-dealer. The wholesale fees are for providing wholesale support services to registered representatives of the retail broker-dealer who are affiliated with at least a plurality of the partial owners and are received based on sales of investment products by the retail broker-dealer. The computer processor operated by the wholesale broker-dealer is configured for performing on a recurring basis the steps of: allocating among at least a plurality of the partial owners the wholesale fees received by the wholesale broker-dealer and expenses incurred by the wholesale broker-dealer in relation to providing the wholesale support services, determining distributions for at least a plurality of the partial owners based on a difference between the wholesale fees and the expenses allocated to the respective partial owners, and effecting the distributions. The computer processor operated by the retail broker-dealer is configured for distributing the commissions received by the retail broker-dealer among the registered representatives. Each computer processor operated by one of the partial owners is configured for: receiving data indicative of the distribution for the respective partial owner and disbursing a payment to the wholesale broker-dealer if the distribution for the respective partial owner is a loss to be paid by the respective partial owner to the wholesale broker-dealer.

According to another aspect, the invention relates to a system for enabling partial owners of a wholesale broker dealer to participate in providing investment products. The system includes first and second storing modules, an allocation module, a distribution module, and an effecting module. The first storing module stores in computer memory data indicative of wholesale fees received by a wholesale broker-dealer for providing wholesale support services to registered representatives of a separate retail broker-dealer who are affiliated with at least a plurality of the partial owners. The wholesale fees are received based on sales of investment products by the retail broker-dealer. The second storing module stores in computer memory data indicative of expenses incurred by the wholesale broker-dealer in relation to providing the wholesale support services. The allocation module allocates, on a recurring basis, the wholesale fees and the expenses stored in the computer memory among at least a plurality of the partial owners. The distribution module determines, on a recurring basis, a distribution for each of at least a plurality of the partial owners based on a difference between the wholesale fees and the expenses allocated to the respective partial owner. The effecting module effects, on a recurring basis, the distributions. In some embodiments, the system includes a reports module for generating reports comprising at least one of the determined distributions for receipt by computer systems operated by the partial owners.

### BRIEF DESCRIPTION OF THE DRAWINGS

The invention may be better understood from the following illustrative description with reference to the following drawings.

FIG. 1 is a block diagram depicting entities which may use the systems described herein and their relationships relative to one another, according to an illustrative embodiment of the invention.

FIG. 2 is a block diagram of a system for enabling partial owners of a wholesale broker-dealer to participate in providing investment products, according to an illustrative embodiment of the invention.

FIG. 3 is a block diagram of computer architecture suitable for implementing various computing devices depicted in the system of FIG. 2.

FIG. 4 is a functional block diagram of a system for enabling partial owners of a wholesale broker-dealer to participate in providing investment products, according to an illustrative embodiment of the invention.

FIG. 5 is an exemplary report that may be generated by the system depicted in FIG. 4.

FIG. 6 depicts a system of modules for enabling partial owners of a wholesale broker-dealer to participate in providing investment products, according to an illustrative embodiment of the invention.

FIG. 7 is a flow chart of a method for enabling partial owners of a wholesale broker-dealer to participate in providing investment products, according to an illustrative embodiment of the invention.

### DESCRIPTION OF CERTAIN ILLUSTRATIVE EMBODIMENTS

To provide an overall understanding of the invention, certain illustrative embodiments will now be described. However, it will be understood by one of ordinary skill in the art that the methods and systems described herein may be adapted and modified as is appropriate for the application being addressed and that the systems and methods described herein may be employed in other suitable applications, and that such other additions and modifications will not depart from the scope thereof.

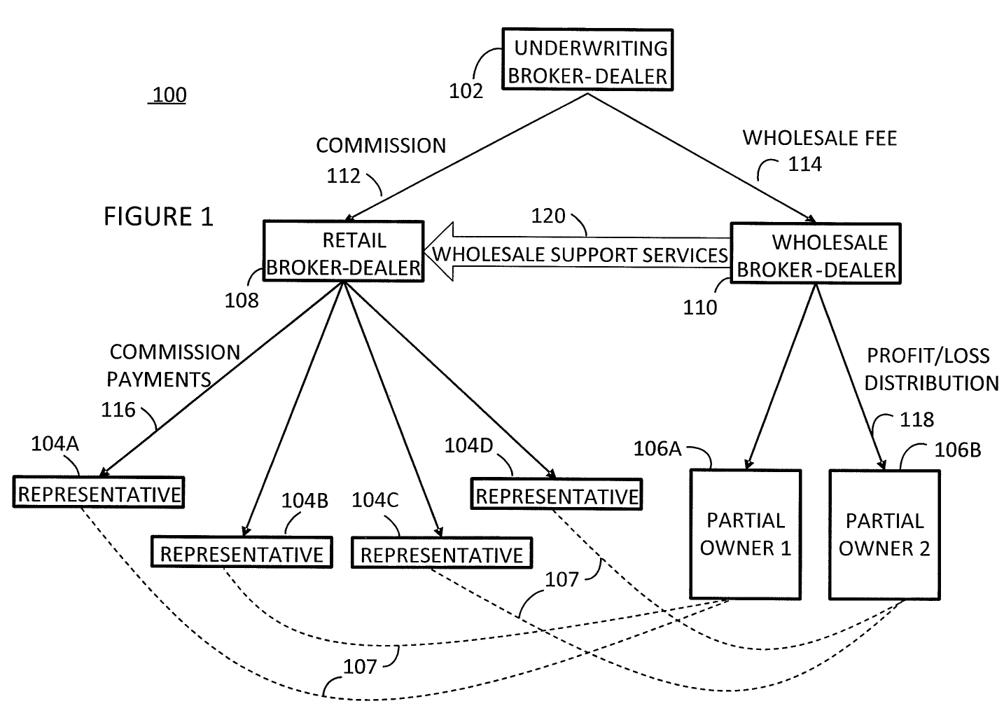

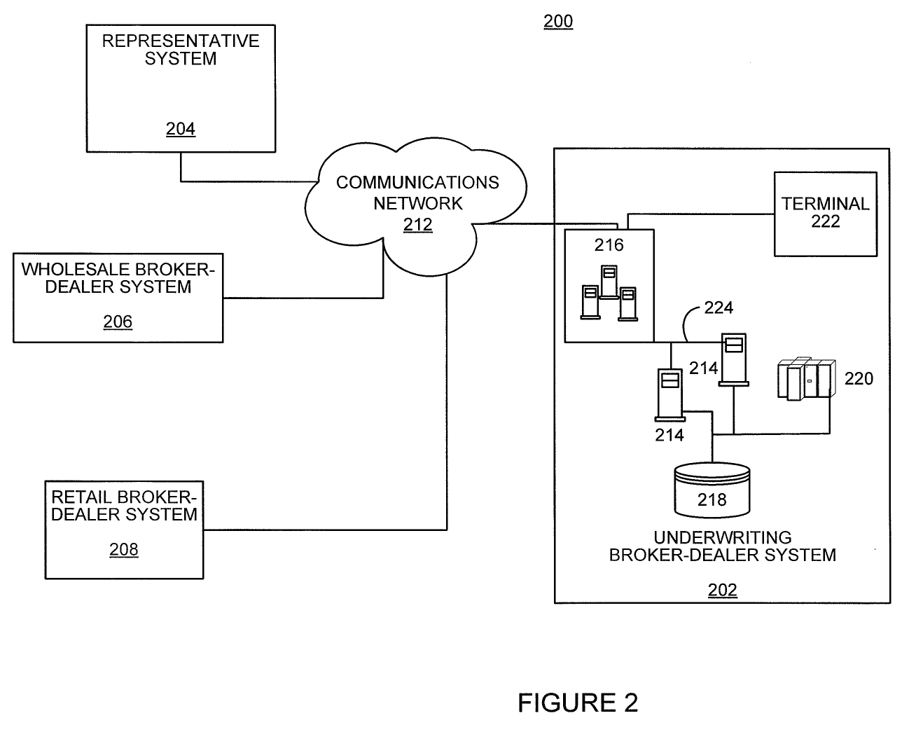

FIG. 1 is a block diagram depicting entities 100 which may use systems and methods for enabling partial owners of a wholesale broker-dealer to participate in providing investment products, as described herein, according to an illustrative embodiment of the invention. In particular, FIG. 1 depicts the relationships between the entities depicted therein. The term “investment product”, as used herein, shall refer to a security, collective trust, investment insurance product, or other similar product sold by a registered representative of a broker-dealer. The customer may be an individual or a business seeking fixed or variable annuities, mutual funds, life insurance, disability insurance, and/or other products for purposes of retirement planning, estate planning, and/or protection against financial uncertainties associated with death or disability. In particular, the methods and systems described herein are particularly well suited for, but are not limited to, handling the investment product needs of small businesses. Systems and methods for effecting the relationships depicted in FIG. 1 are described below with respect to FIGS. 2-6. In particular, systems and methods for exchanging data and disbursements between the entities 100 are further described below.

An underwriting broker-dealer 102 underwrites for an issuing company, the securities that are available for sale to the public for a fee. The investment products administered by underwriting broker-dealer 102 are sold by representatives 104a, 104b, 104c, and 104d of a retail broker-dealer 108 who are licensed or registered to sell securities for example, with the Financial Industry Regulatory Authority (“FINRA”) and/or with the appropriate state agency or board. Each representative 104 is affiliated with a partial owner 106a or 106b of a wholesale broker-dealer 110. The affiliations are depicted in FIG. 1 with dashed affiliation lines 107. For example, each representative 104 may be an employee of one of the partial owners 106. In some embodiments, at least some of the partial owners 106 are non-broker-dealers, such as property and casualty insurance agencies that provide insurance policies for businesses and/or individuals, such as worker's compensation, property, automobile, liability, and home-owner policies, and representatives 104 are both registered representatives of a broker deal and also insurance agents affiliated with or employed by the agencies. Partial owners may also be other providers of business services who do not have a broker-dealer license, but whose customers may be interested in investment products. Exemplary partial owners 106 include payroll organizations, preferred provider organizations (“PPOs”), certified public accountants (“CPAs”), benefits providers, law firms, and consulting firms. Individuals may also be partial owners 106. The number of partial owners who use the systems and methods described herein and the number of representatives per partial owner may vary without departing from the scope of the invention.

Representatives 104 receive support services from retail and wholesale broker-dealers 108 and 110. Retail broker-dealer 108 provides retail support services such as overseeing representatives or assisting representatives to become licensed or registered. In addition, the retail broker-dealer 108 serves as broker-dealer for the representatives 104, such as by buying and selling securities on behalf of the underwriting broker-dealer 102 or issuer to the representatives' customers. Wholesale broker-dealer 110 provides wholesale support services 120 to retail broker-dealer 108. Exemplary wholesale support services 120 include education and training with respect to the investment products underwritten by the underwriting broker-dealer, including how to market investment products; assistance in business development, including providing marketing materials and sales leads; and coordination of the establishment and administrative needs of an investment product (e.g., retirement plan or mutual fund) for a customer. The retail broker-dealer 108 may have representatives, other than representatives 104, who are not affiliated with partial owners 106 and do not receive wholesale support services from wholesale broker-dealer 110. Partial owners 106, with which representatives 104 are affiliated, each own an interest in wholesale broker-dealer 110. Optionally, underwriting broker-dealer 102, or an affiliate, also owns an interest in wholesale broker-dealer 110. Wholesale broker-dealer 110 has employees such as regional sales directors (“RSDs”) each of whom provide support services to representatives 104 of a particular geographic region. In some embodiments, a single broker-dealer performs the services of wholesale and retail broker-dealers 108 and 110. In some embodiments, wholesale broker-dealer 110 provides wholesale support services to multiple retail broker-dealers.

Underwriting broker-dealer 102 disburses payments arising from sales of investment products transacted by representatives 104. In particular, underwriting broker-dealer 102 pays commissions 112 and wholesale fees 114 to retail broker-dealer 108 and wholesale broker-dealer 110, respectively. Commissions 112 are determined based on the value and/or volume of sales of investment products transacted by representatives 104. Retail broker-dealer 108, in turn, disburses commission payments 116 to individual representatives 104 based on their individual sales. Wholesale fees 114 are determined based on services 120 rendered by wholesale broker-dealer 110. For example, each type of investment product may correspond to a specific wholesale fee rate which is used to determine wholesale fees for services 120 rendered regarding that type of investment product. In some embodiments, wholesale broker-dealer 110 provides wholesale support services for investment products issued, carried, or underwritten by multiple underwriting broker-dealers, in which case wholesale broker-dealer 110 receives wholesale fees from the multiple underwriting broker-dealers.

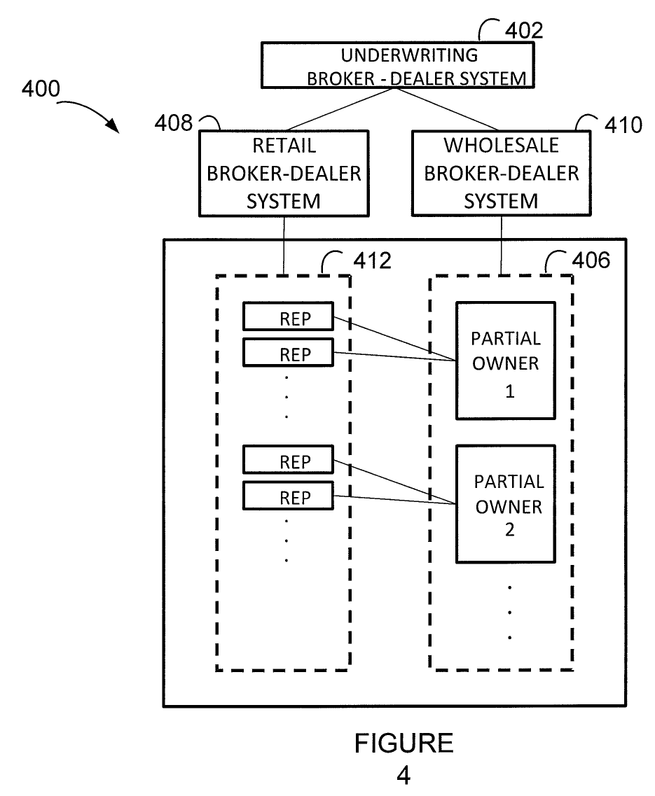

Wholesale broker-dealer 110, in turn, determines and disburses distributions 118, which represent either a profit or a loss, to partial owners 106. Wholesale broker-dealer 110 determines distributions 118 by first allocating revenues received, such as wholesale fees 114, and expenses incurred among its owners, which include partial owners 106. Revenue and expenses are allocated to the partial owners 106 by allocating revenue and expenses to distinct divisions within the wholesale broker-dealer 110 associated with respective partial owners 106. Wholesale broker-dealer 110 then calculates a partial owner's distribution based on the difference between its allocated revenues and allocated expenses. Allocations of revenues and expenses to a partial owner may correspond to a membership interest that the respective partial owner has in the wholesale broker-dealer 110, which may be governed, for example, by an agreement establishing the wholesale broker-dealer 110 (e.g., a limited liability company agreement). In some embodiments, the distributions 118 are determined at the end of each fiscal year, based on allocations of revenues and expenses for that fiscal year. A partial owner's distribution is a profit, namely the partial owner receives a payment, if the allocated revenues for that partial owner exceed its allocated expenses. A partial owner's distribution is a loss, namely the partial owner must pay into a capital account of the wholesale broker-dealer 110, if the allocated expenses for that partial owner exceed its allocated revenues. Distribution determinations are described further in relation to FIG. 4.

FIG. 2 is a block diagram of a system 200 for enabling partial owners of a wholesale broker dealer to participate in providing investment products, according to an illustrative embodiment of the invention. System 200 includes an underwriting broker-dealer system 202 in communication with registered representative system 204 and wholesale and retail broker-dealer systems 206 and 208, each of which is operated by a corresponding entity as described above with respect to FIG. 1. In particular, underwriting broker-dealer system 202 is operated by an entity similar to underwriting broker-dealer 102 of FIG. 1. Registered representative system 204 is operated by a user similar to representative 104 of FIG. 1 affiliated with a partial owner 106 of FIG. 1. In some embodiments, system 200 includes multiple registered representative systems 204 each operated by a different registered representative. Wholesale and retail broker-dealer systems 206 and 208 are operated by broker-dealers similar to wholesale and retail broker-dealers 110 and 108, respectively, of FIG. 1. In some embodiments, a single broker-dealer system performs the functions of the wholesale and retail broker-dealer systems described herein.

The underwriting broker-dealer system 202 communicates with the systems 204, 206, and 208 over one or a combination of communication networks 212. The communication networks 212 may be wired, wireless, or a combination thereof. They may be publicly accessible, such as the Internet, or part of a private communications network. Preferably, at least portions of communications over the communication networks 212 are encrypted to protect the privacy of customers.

The systems 204, 206, and 208 may include any computing device known in the art capable of networked communication and having a microprocessor capable of executing the user interfaces and processes described herein. In particular, the broker-dealer systems 206 and 208 include software for providing a user interface to users of their respective services and/or generating reports for receipt by partial owner systems. The software may include a thin or thick client, or it may take the form of browser executable code for providing a user interface via a standard Internet browser software application.

The underwriting broker-dealer system 202 includes a plurality of application servers 214, a plurality of load balancing proxy servers 216, a data warehouse 218, a business logic processor 220, and one or more terminals 222. These computing devices are connected by a local area network 224.

The application servers 214 are responsible for interacting with the systems 204, 206, and 208. For example, the application servers 214 include software for generating web pages for communication to the systems 204, 206, and 208. These web pages serve as user interfaces for the registered representative, wholesale broker-dealer, and retail broker-dealer, respectively, to interact with the underwriting broker-dealer system 202. The load balancing proxy servers 216 operate to distribute the load among application servers 214.

The data warehouse 218 is the main electronic depository of the underwriting broker-dealer's current and historical data. The data warehouse 218 includes one or more interrelated databases that store information relevant to the provision of investment products, such as information related to the types and values of securities sold by various representatives and/or broker-dealers. The interrelated databases store both structured and unstructured data. Databases in the interrelated databases store data, for example, in a relational database, in various data fields keyed to various identifiers, such as, without limitation, customer, representative, broker-dealer, or type of investment product. The information stored in the data warehouse 218 is obtained through communications with representatives, broker-dealers, and third party data sources.

The business logic processor 220 includes one or more computing devices tasked with carrying out determinations of prices, distributions, commissions, wholesale fees, and any other payments relating to the provision of investment products. In particular, the business logic processor 220 is configured to generate reports for receipt by broker-dealers, such as reports of commissions for registered representatives and wholesale fees for the wholesale broker-dealer, and/or to initiate transfers or disbursements of money according to the values determined.

The terminals 222 provide various user interfaces to underwriting broker-dealer employees to interact with the business logic processor 220. The interfaces include, without limitation, interfaces to add new investment products to the underwriting broker-dealer system 202 and to adjust the processes utilized by the business logic processor 220 to generate reports or calculate any other values. Such interfaces may be integrated into one or more websites for managing the underwriting broker-dealer system 202 presented by the application servers 214, or they may be integrated into thin or thick software clients. The terminals 222 can be any computing devices suitable for carrying out the processes described above, including personal computers, lap top computers, personal digital computers, and other computing devices with general purpose processors.

In some embodiments, the wholesale broker-dealer system and/or the retail broker-dealer system is similar to the underwriting broker-dealer system 202. In particular, a broker-dealer system may have some or all of the devices described above as being part of the underwriting broker-dealer system 202. A retail broker-dealer may have application servers for providing web interfaces to registered representatives, a business logic processor for determining commissions for registered representatives, and a terminal for providing user interfaces to retail broker-dealer employees to allow, for example, employees to enter applications for investment products. A wholesale broker-dealer may have application servers for providing web interfaces to employees of the retail broker-dealer, a business logic processor for determining profit distributions for the partial owners, and a terminal for providing user interfaces to wholesale broker-dealer employees.

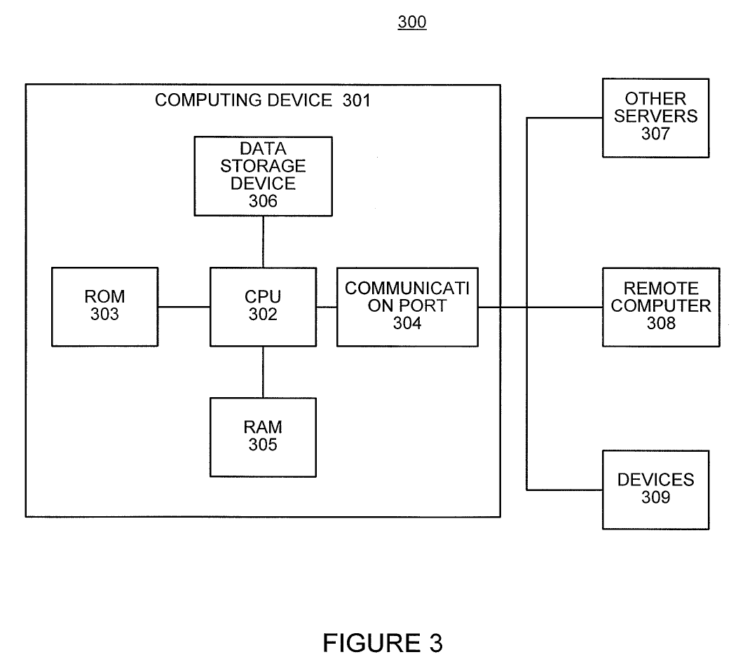

FIG. 3 is a block diagram of a computer architecture 300 suitable for implementing various computing devices 301 incorporated into the system 200, including, for example, the application servers 214 and the business logic processor 220.

Computing device 301 comprises at least one central processing unit (CPU) 302, at least one read-only memory (ROM) 303, at least one communication port or hub 304, at least one random access memory (RAM) 305, and one or more databases or data storage devices 306. All of these later elements are in communication with the CPU 302 to facilitate the operation of the computing device 301. The computing device 301 may be configured in many different ways. For example, computing device 301 may be a conventional standalone server computer or alternatively, the function of server may be distributed across multiple computing systems and architectures.

Computing device 301 may be configured in a distributed architecture, wherein databases and processors are housed in separate units or locations. Some such servers perform primary processing functions and contain at a minimum, a general controller or a processor 302, a ROM 303, and a RAM 305. In such an embodiment, each of these servers is attached to a communications hub or port 304 that serves as a primary communication link with other servers 307, client or user computers 308 and other related devices 309. The communications hub or port 304 may have minimal processing capability itself, serving primarily as a communications router. A variety of communications protocols may be part of the system, including but not limited to: Ethernet, SAP, SAS™, ATP, BLUETOOTH™, GSM and TCP/IP.

The CPU 302 comprises a processor, such as one or more conventional microprocessors and one or more supplementary co-processors such as math co-processors. The CPU 302 is in communication with the communication port 304 through which the CPU 302 communicates with other devices such as other servers 307, user terminals 308, or devices 309. The communication port 304 may include multiple communication channels for simultaneous communication with, for example, other processors, servers or client terminals. Devices in communication with each other need not be continually transmitting to each other. On the contrary, such devices need only transmit to each other as necessary, may actually refrain from exchanging data most of the time, and may require several steps to be performed to establish a communication link between the devices.

The CPU 302 is also in communication with the data storage device 306. The data storage device 306 may comprise an appropriate combination of magnetic, optical and/or semiconductor memory, and may include, for example, RAM, ROM, flash drive, an optical disc such as a compact disc and/or a hard disk or drive. The CPU 302 and the data storage device 306 each may be, for example, located entirely within a single computer or other computing device; or connected to each other by a communication medium, such as a USB port, serial port cable, a coaxial cable, a Ethernet type cable, a telephone line, a radio frequency transceiver or other similar wireless or wired medium or combination of the foregoing. For example, the CPU 302 may be connected to the data storage device 306 via the communication port 304.

The data storage device 306 may store, for example, (i) a program (e.g., computer program code and/or a computer program product) adapted to direct the CPU 302 in accordance with the present invention, and particularly in accordance with the processes described in detail hereinafter with regard to the CPU 302; (ii) databases adapted to store information that may be utilized to store information required by the program. Suitable databases include data warehouse 218 of FIG. 2.

The program may be stored, for example, in a compressed, an uncompiled and/or an encrypted format, and may include computer program code. The instructions of the program may be read into a main memory of the processor from a computer-readable medium other than the data storage device 306, such as from a ROM 303 or from a RAM 305. While execution of sequences of instructions in the program causes the processor 302 to perform the process steps described herein, hard-wired circuitry may be used in place of, or in combination with, software instructions for implementation of the processes of the present invention. Thus, embodiments of the present invention are not limited to any specific combination of hardware and software.

Suitable computer program code may be provided for performing numerous functions such as recording sales of investment products, generating reports based on sales of investment products, and calculating distributions, commissions, wholesale fees, or expenses related to investment products. The program also may include program elements such as an operating system, a database management system and “device drivers” that allow the processor to interface with computer peripheral devices (e.g., a video display, a keyboard, a computer mouse, etc.).

The term “computer-readable medium” as used herein refers to any medium that provides or participates in providing instructions to the processor of the computing device (or any other processor of a device described herein) for execution. Such a medium may take many forms, including but not limited to, non-volatile media and volatile media. Non-volatile media include, for example, optical, magnetic, or opto-magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, or any other medium from which a computer can read.

Various forms of computer readable media may be involved in carrying one or more sequences of one or more instructions to the processor 302 (or any other processor of a device described herein) for execution. For example, the instructions may initially be borne on a magnetic disk of a remote computer 308. The remote computer 308 can load the instructions into its dynamic memory and send the instructions over an Ethernet connection, cable line, or even telephone line using a modem. A communications device 304 local to a computing device (or, e.g., a server) can receive the data on the respective communications line and place the data on a system bus for the processor. The system bus carries the data to main memory, from which the processor retrieves and executes the instructions. The instructions received by main memory may optionally be stored in memory either before or after execution by the processor. In addition, instructions may be received via a communication port as electrical, electromagnetic or optical signals, which are exemplary forms of wireless communications or data streams that carry various types of information.

As previously discussed with reference to FIG. 2, servers may also interact and/or control one or more user devices 309, such as displays and printers, or remote computers 308 such as, registered representative system 204, wholesale broker-dealer system 206, and terminals 222. These systems and terminals may include any one or a combination of a personal computer, a laptop, a personal digital assistant, a mouse, a keyboard, a computer display, a touch screen, LCD, voice recognition software, or other input/output devices required to implement the above functionality.

FIG. 4 is a functional block diagram of a system 400 for enabling partial owners of a wholesale broker-dealer to participate in providing investment products, according to an illustrative embodiment of the invention. The system 400 includes an underwriting broker-dealer system 402, retail and wholesale broker-dealer systems 408 and 410, and a plurality of partial owner systems 406, which are similar to those described above with respect to FIG. 2 and may communicate over a communications network similar to network 212 of FIG. 2.

The underwriting broker-dealer system 402 is operated by an entity similar to underwriting broker-dealer 102 of FIG. 1. Each partial owner system 406 is operated by a partial owner similar to partial owner 106 of FIG. 1, such as a property and casualty insurance agency. Partial owner system 406 includes a plurality of registered representative terminals 412 for use by affiliated registered representatives, similar to representatives 104 of FIG. 1, each of whom is affiliated with a partial owner. Retail and wholesale broker-dealer systems 408 and 410 are operated by broker-dealers providing, respectively, retail and wholesale support services for investment products to registered representatives (similar to retail and wholesale broker-dealers 108 and 110 of FIG. 1). In some embodiments, a single broker-dealer system performs the functions of the wholesale and retail broker-dealer systems described herein.

Retail broker-dealer system 408 may provide a form or user interface to the registered representative terminals 412 (e.g., a web interface provided by an application server of retail broker-dealer system 408 and displayed on a registered representative terminal of registered representative system 406) for allowing an affiliated registered representative to establish or record a sale to a customer of an investment product offered by the underwriting broker-dealer. Information collected by the form or user interface can be stored in a database of retail broker-dealer system 408 and/or transmitted to underwriting broker-dealer system 402 to be stored.

Underwriting broker-dealer system 402 maintains investment products, such as mutual funds or retirement plans, by executing investments on behalf of and collecting payments into a customer's investment product. Underwriting broker-dealer system 402 may also disburse payments to registered representatives and/or broker-dealers arising from an investment product, such as commissions or fees, via, for example, an accounting system shared by the systems of FIG. 4. Generally, underwriting broker-dealer system 402 performs standard operations usually performed by a financial services system for purposes of managing and issuing investments. In some embodiments, underwriting broker-dealer system 402 provides forms or user interfaces (e.g., a web interface) to be displayed by retail broker-dealer system 408 to allow an employee of the retail broker-dealer to manually enter applications for investment products, where applications are received from a registered representative. In some embodiments, underwriting broker-dealer system 402 provides forms or user interfaces (e.g., a web interface) to be displayed by partial owner system 406, for example by registered representative terminal 412, to registered representatives to manually enter applications for investment products. Underwriting broker-dealer system 402 can generate customized forms or user interfaces for use by retail broker-dealer system 408 or partial owner system 406.

Sales information collected by retail broker-dealer system 408 may be transmitted as a report (e.g., as a spreadsheet, data file, or other data indicative of the information) of sales transacted over a predetermined period of time (e.g., month, fiscal quarter, or year), over a manually entered time range, since a last report was output, or in real-time. The timing of transmissions of sales information may be different than the timing of payments or disbursements arising from the sales. For example, transacted sales may be reported each month while commissions are disbursed each fiscal quarter. Exemplary sales information includes parameters of the investment product, customer identification, registered representative who transacted the sale, and the partial owner with which the registered representative is affiliated. The report may be organized by registered representative and/or partial owner.

Underwriting broker-dealer system 402 includes a processor configured to calculate sales commissions to be paid by the underwriting broker-dealer for receipt by each registered representative based on sales transacted by the respective registered representative. The underwriting broker-dealer system 402 disburses the calculated commissions to each registered representative or to the retail broker-dealer system 408, which then would in turn disburse the appropriate commission to each registered representative. A report including the commissions calculated for each registered representative can form a report to be transmitted to the retail broker-dealer system 408. Alternatively, retail broker-dealer system 408 includes a processor configured to calculate the commissions and to transmit a bill for the commissions to the underwriting broker-dealer system 402.

Underwriting broker-dealer system 402 includes a processor configured to calculate wholesale fees to be paid by the underwriting broker-dealer to the wholesale broker-dealer, for wholesaling services provided by the wholesale broker-dealer to the registered representatives and partial owners. Rates for wholesale fees are stored in a database of the underwriting broker-dealer system 402 for use by the processor. Such rates may depend on the specific investment product for which wholesale support services are provided. The processor may generate a report, such as a spreadsheet, of the calculated wholesale fees to be transmitted for receipt by wholesale broker-dealer system 410. Reports may be configured to be displayed to an employee of the wholesale broker-dealer on, for example, a user terminal of wholesale broker-dealer system 410 and/or to be stored in a database of wholesale broker-dealer system 410. Such reports may be transmitted automatically, such as via a script, or in response to a request, such as a web service request, received from the wholesale broker-dealer system 410. Automatically-generated reports may be generated on a periodic basis, such as each month or each fiscal quarter. Reports may be generated in response to input from an employee of the underwriting broker-dealer using a user terminal of the underwriting broker-dealer system 402. The processor may be further configured to disburse the calculated wholesale fees for receipt by the wholesale broker-dealer system 410. Alternatively, wholesale broker-dealer system 410 includes a processor configured to calculate the wholesale fees and/or transmit a bill for the wholesale fees for receipt by the underwriting broker-dealer system 402.

Wholesale broker-dealer system 410 includes a processor configured to calculate a profit or loss to be distributed to each partial owner. Profits and losses are allocated to the partial owners by allocating revenue and expenses to distinct divisions within the wholesale broker-dealer associated with respective partial owners. The distribution received by each partial owner is based on revenues and expenses of the wholesale broker-dealer that are allocated to the respective partial owner. If the allocated expenses are higher than the allocated revenue for a partial owner, then the calculated distribution is a loss and the wholesale broker-dealer system 410 bills, or otherwise collects, the difference from the partial owner. Vice versa, if the allocated revenues are higher than the allocated expenses for a partial owner, then the calculated distribution is a profit and the wholesale broker-dealer system 410 generates a report for transmittal to or disburses the profit to the partial owner system 406.

Revenues primarily comprise wholesales fees received from the underwriting broker-dealer and are allocated to each owner of the wholesale broker-dealer, namely to each partial owner and to the underwriting broker-dealer if the underwriting broker-dealer is also an owner. Revenue allocated to each partial owner is based on sales generated by the registered representatives affiliated with the respective partial owner. Revenue allocation may also be based on the initial capital contribution made by a partial owner at the creation of the wholesale broker-dealer. In some embodiments in which the underwriting broker-dealer at least partially owns the wholesale broker-dealer, between about 5% and about 15% of the wholesaling revenues received will be credited to the underwriting broker-dealer or affiliate owner and the remaining amount will be allocated to the partial owners, based on the wholesaling activities for each partial owner.

Expenses include fixed expenses, direct expenses, and variable costs. Exemplary expenses include salaries, incentives, wholesale representative fees, audit fees, and travel and entertainment for wholesale representatives. Expense allocation depends on the type of expense. In particular, fixed expenses, such as audit fees or other expenses common to all partial owners are allocated evenly among the partial owners or proportionately among the partial owners according to their ownership interest. Direct expenses, i.e., expenses that are specific to a particular partial owner, are allocated to that partial owner. For example, travel and entertainment expenses may be directly allocated to the partial owner whose registered representatives the wholesale representative visited. Variable expenses are allocated based on relative sales transacted by the partial owners. For example, variable expenses may be charged to each partial owner based upon the partial owner's revenue relative to the total revenue for all partial owners for that period.

Reports including revenue allocation, expense allocation, and/or distributions for a partial owner may be generated and transmitted by wholesale broker-dealer system 410 for receipt by each partial owner system 406. Reports may list revenues received by a partial owner and specific expenses incurred by or allocated to a partial owner, organized by partial owner, year, quarter, and/or month. Reports may also list the total value of sales transacted by registered representatives of a partial owner over the relevant period and the percentage it represents out of total sales over all partial owners. A report may include information relating to all partial owners or solely to the specific partial owner that receives the report. A report may include summary information relating to all partial owners and more detailed information relating to a specific partial owner.

Reports may be configured to be displayed to an employee of the partial owner on, for example, a user terminal of partial owner system 406 and/or to be stored in a database of partial owner system 406. Such reports may be transmitted automatically, such as via a script, or in response to a request, such as a web service request, received from a partial owner system 406. Automatically-generated reports may be generated on a periodic basis, such as each month or each fiscal quarter. Reports may be generated in response to input from an employee of the wholesale broker-dealer using a user terminal of the wholesale broker-dealer system 410. The processor may be further configured to disburse the calculated distributions for receipt by partial owner systems 406.

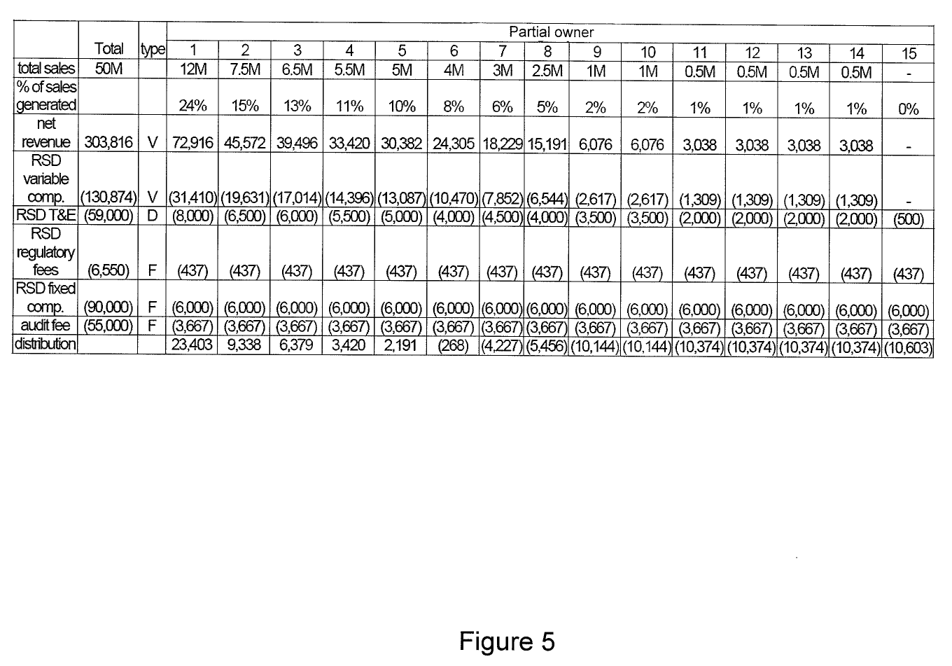

An exemplary report that may be displayed to a user is depicted in FIG. 5. In the example depicted in FIG. 5, a wholesale broker-dealer is owned by 15 partial owners having sales totaling $50,000,000 (50M), which corresponds to $303,816 in net revenues from wholesale fees corresponding to those sales, i.e., total revenues less the revenues allocated to a underwriting broker dealer(or affiliate thereof) owner. The categories of revenues and expenses to be allocated are listed in the left-most column, followed by their corresponding total values in the next column, the type of allocation to be applied to each category in the third column, and finally the allocations to each partial owner in the remaining columns. The categories include wholesale fee revenues (“net revenue”), variable and fixed compensation for employees of the wholesale broker dealer (“RSD variable comp.” and “RSD fixed comp.”), travel and entertainment expenses incurred by the employees (“RSD T&E”), and regulatory and audit fees (“RSD regulatory fees” and “audit fee”). Types of allocations include variable (“V”), direct (“D”), and fixed (“F”). Variable allocations, such as wholesale fee revenues, are allocated to each of the 15 partial owners in proportion to the percentage of sales generated by the respective partial owner. For example, in the illustrative report, $72,916 of revenues, which represents 24% of the total $303,816 revenues, is allocated to partial owner 1 because registered representative(s) affiliated with partial owner 1 had sales totaling $12 million, which is 24% of the $50 million total sales. Direct allocations are allocated directly to the partial owner which incurred the expense (e.g., travel and entertainment expenses for wholesale broker-dealer employees to visit registered representatives affiliated with a specific partial owner are allocated to that specific partial owner). Fixed expense allocations are divided equally among the 15 partial owners. The last row lists the difference between allocated revenues and expenses for each partial owner. In alternative implementations, fixed expenses may be allocated based in part on each partial owner's capital contribution to the wholesale broker dealer.

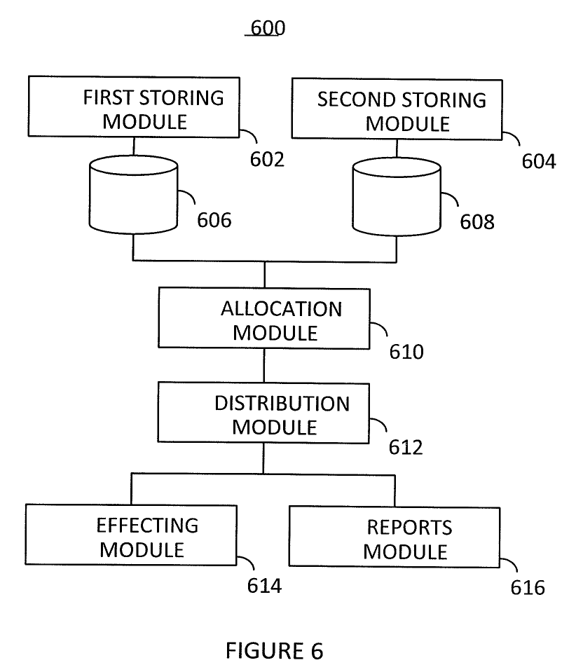

Generally, calculations executed by any of the processors described above with respect to FIG. 4 may be implemented by one or more software, hardware, or firmware modules (or a combination thereof) in communication with a user interface, for providing access to and displaying results of the module, and, if necessary, a database in which information necessary to execute the calculations is stored (e.g., wholesale fee rates, values of sales, expenses incurred). FIG. 6 depicts a system of modules 600 for enabling partial owners of a wholesale broker-dealer to participate in providing investment products, according to an illustrative embodiment of the invention. System 600 includes first and second storing modules 602 and 604, computer memories 606 and 608, an allocation module 610, a distribution module 612, and an effecting module 614. In some embodiments, system 600 also includes a reports module 616.

As used herein, a “module” may be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module. Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. In addition, entire modules, or portions thereof, may also be implemented in programmable hardware devices such as field programmable gate arrays, programmable array logic, programmable logic devices or the like or as hardwired integrated circuits.

The first storing module 602 stores in computer memory 606 data indicative of wholesale fees received by a wholesale broker-dealer for providing wholesale support services to registered representatives of a separate retail broker-dealer. The registered representatives are affiliated with at least a plurality of the partial owners. The wholesale fees are received based on sales of investment products by the retail broker-dealer. The second storing module 604 stores in computer memory 608 data indicative of expenses incurred by the wholesale broker-dealer in relation to providing the wholesale support services. Computer memories 606 and 608 may be separate devices or the same device and may be a database or other data storage device, such as any of those described above with respect to FIG. 3.

The allocation module 610 allocates, on a recurring basis, the wholesale fees and the expenses stored in computer memories 606 and 608 among at least a plurality of the partial owners. In some embodiments, the allocation module 610 allocates wholesale fees and/or expenses to partial owners based on the wholesale support services received by registered representatives affiliated with the respective partial owners. The distribution module 612 determines, on a recurring basis, a distribution for each of at least a plurality of the partial owners based on a difference between the wholesale fees and the expenses allocated to the respective partial owner. The distribution may be a profit for receipt by the respective partial owner or a loss to be paid by the respective partial owner to the wholesale broker-dealer. The effecting module 614 effects, on a recurring basis, the distributions. The reports module 616 generates reports including at least one of the determined distributions for receipt by computer systems operated by the partial owners. Generated reports may be displayed to employees affiliated with the partial owners via a user interface, such as those described above. Exemplary reports are described above with respect to FIGS. 4 and 5.

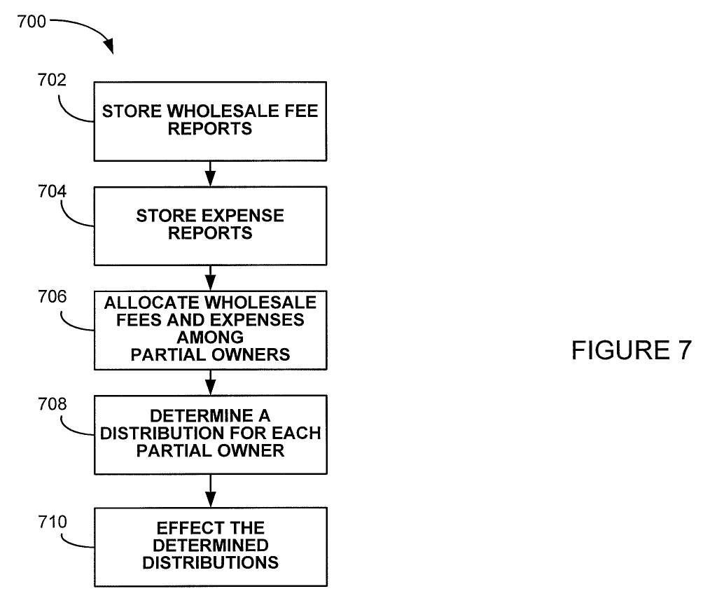

FIG. 7 is a flow chart of a method 700 for enabling partial owners of a wholesale broker dealer to participate in providing investment products, according to an illustrative embodiment of the invention. The method begins with storing reports of wholesale fees received by a wholesale broker-dealer for providing the wholesale support services to registered representatives of a retail broker-dealer (step 702) and storing reports of expenses incurred by the wholesale broker-dealer in relation to providing the wholesale support services (step 704). The registered representatives are affiliated with the partial owners. Exemplary reports are described above with respect to FIGS. 4 and 5. Next, the wholesale fees and the expenses are allocated among the partial owners (step 706). Various types of revenues and expenses and systems and methods for their allocation are described above with respect to FIGS. 1-6. At step 708, a distribution is determined for each partial owner based on a difference between the wholesale fees and the expenses allocated to the respective partial owner. In some embodiments, the distribution received by a partial owner is equal to this difference. A distribution is either a profit or loss, depending on whether allocated revenues exceed allocated expenses for a particular partial owner. At step 710, the distributions are effected, resulting in either a payment of profits from the wholesale broker-dealer to the partial owner or the partial owner paying the amount of the loss to the wholesale broker-dealer. Systems and methods for determining and effecting distributions are described above with respect to FIG. 1-6.

The invention may be embodied in other specific forms without departing from the spirit or essential characteristics thereof. The foregoing embodiments are therefore to be considered in all respects illustrative, rather than limiting of the invention.

What is claimed is:

1. A system for enabling partial owners of a wholesale broker dealer to participate in providing investment products, comprising:
a computer processor operated by an underwriting broker-dealer and configured for:
disbursing payments of wholesale fees to the wholesale broker-dealer for providing wholesale support services to registered representatives of a separate retail broker-dealer who are affiliated with respective partial owners, wherein the wholesale fees are received based on sales of investment products by the retail broker-dealer, and
disbursing payments of commissions to the retail broker-dealer,
a computer processor operated by the wholesale broker-dealer and configured for performing on a recurring basis the steps of:
allocating among at least a plurality of the partial owners the wholesale fees received by the wholesale broker-dealer and expenses incurred by the wholesale broker-dealer in relation to providing the wholesale support services,
determining a distribution for each of at least a plurality of the partial owners based on a difference between the wholesale fees and the expenses allocated to the respective partial owners, and
effecting the distributions,
a computer processor operated by the retail broker-dealer and configured for distributing the commissions received by the retail broker-dealer among the registered representatives, and
computer processors each operated by one of the partial owners and configured for:
receiving data indicative of the distribution for the respective partial owner, and
disbursing a payment to the wholesale broker-dealer if the distribution for the respective partial owner is a loss to be paid by the respective partial owner to the wholesale broker-dealer.

2. The system of claim 1, wherein at least a plurality of the partial owners are non-broker dealers.

3. The system of claim 2, wherein an underwriting broker-dealer or an affiliate thereof owns an interest in the wholesale broker-dealer.

4. The system of claim 1, wherein the processor operated by the wholesale broker-dealer is configured to allocate the wholesale fees and the expenses to each of at least a plurality of the partial owners based in part on the wholesale support services received by registered representatives affiliated with the respective partial owners.

5. The system of claim 1, wherein
the data indicative of the distribution for a respective partial owner comprises a report comprising at least one of the determined distributions, and
the processor operated by the wholesale broker-dealer is further configured for performing on a recurring basis the steps of generating and outputting reports comprising at least one of the determined distributions for receipt by the computer processors operated by at least a plurality of the partial owners.

6. A data processing system for enabling partial owners of a wholesale broker-dealer to participate in providing investment products, comprising:
a computer memory for
storing data indicative of wholesale fees received by the wholesale broker-dealer for providing wholesale support services to registered representatives of a separate retail broker-dealer who are affiliated with respective ones of the partial owners, wherein the wholesale fees are received based on sales of investment products by the retail broker-dealer, and
storing data indicative of expenses incurred by the wholesale broker-dealer in relation to providing the wholesale support services, and
a computer processor operated by the wholesale broker-dealer and configured for performing on a recurring basis the steps of:
allocating the wholesale fees and the expenses stored in the computer memory among at least a plurality of the partial owners,
determining a distribution for at least a plurality of the partial owners based on a difference between the wholesale fees and the expenses allocated to respective partial owners, and
effecting the distributions.

7. The data processing system of claim 6, wherein at least a plurality of the partial owners are non-broker-dealers.

8. The data processing system of claim 7, wherein an underwriting broker-dealer or an affiliate thereof owns an interest in the wholesale broker-dealer.

9. The data processing system of claim 6, wherein the processor is configured to allocate the wholesale fees and the expenses to each partial owner based in part on the wholesale support services received by registered representatives affiliated with the respective partial owners.

10. The data processing system of claim 6, wherein the distribution for each partial owner is one of a profit for receipt by the respective partial owner and a loss to be paid by the respective partial owner to the wholesale broker-dealer.

11. The data processing system of claim 6, wherein the processor is further configured for performing on a recurring basis the steps of generating and outputting reports comprising at least one of the determined distributions to the partial owners.

12. The data processing system of claim 6, wherein the step of effecting the distributions comprises disbursing a payment for receipt by a partial owner.

13. The data processing system of claim 6, wherein at least a plurality of the partial owners are non-broker-dealers.

14. A computerized method for enabling partial owners of a wholesale broker-dealer to participate in providing investment products, comprising:
storing in computer memory, by a wholesale broker computer system, data indicative of wholesale fees received by a wholesale broker-dealer for providing wholesale support services to registered representatives of a separate retail broker-dealer who are affiliated with respective ones of the partial owners, wherein the wholesale fees are received based on sales of investment products by the retail broker-dealer,
storing in computer memory, by the wholesale broker computer system, data indicative of expenses incurred by the wholesale broker-dealer in relation to providing the wholesale support services,
allocating, by the wholesale broker-dealer computer system on a recurring basis, the wholesale fees and the expenses stored in the computer memory among at least a plurality of the partial owners,
determining, by the wholesale broker-dealer computer system on a recurring basis, a distribution for at least a plurality of the partial owners based on a difference between the wholesale fees and the expenses allocated to the plurality of partial owners, and
effecting, by the wholesale broker-dealer computer system on a recurring basis, the distributions.

15. The computerized method of claim 14, wherein at least a plurality of the partial owners are non-broker dealers.

16. The computerized method of claim 15, wherein an underwriting broker-dealer or an affiliate thereof owns an interest in the wholesale broker-dealer.

17. The computerized method of claim 14, wherein the wholesale broker-dealer computer system allocates at least one of the wholesale fees and the expenses to at least a plurality of the partial owners based in part on the wholesale support services received by registered representatives affiliated with the respective partial owner.

18. The computerized method of claim 14, wherein the distribution for the partial owners is one of a profit for receipt by the respective partial owners and a loss to be paid by the respective partial owner to the wholesale broker-dealer.

19. The computerized method of claim 14, comprising generating and outputting, by the wholesale retail broker-dealer computer system on a recurring basis, reports comprising at least one of the determined distributions to at least a plurality of the partial owners.

20. The computerized method of claim 14, wherein effecting the distributions comprises disbursing a payment for receipt by one of the partial owners.

21. A system for enabling partial owners of a wholesale broker dealer to participate in providing investment products, comprising:
a first storing module for storing in computer memory data indicative of wholesale fees received by a wholesale broker-dealer for providing wholesale support services to registered representatives of a separate retail broker-dealer who are affiliated with at least a plurality of the partial owners, wherein the wholesale fees are received based on sales of investment products by the retail broker-dealer,
a second storing module for storing in computer memory data indicative of expenses incurred by the wholesale broker-dealer in relation to providing the wholesale support services,
an allocation module for allocating, on a recurring basis, the wholesale fees and the expenses stored in the computer memory among at least a plurality of the partial owners,
a distribution module for determining, on a recurring basis, a distribution for each of at least a plurality of the partial owners based on a difference between the wholesale fees and the expenses allocated to the respective partial owner, and
an effecting module for effecting, on a recurring basis, the distributions.

22. The system of claim 21, wherein at least a plurality of the partial owners are non-broker dealers.

23. The system of claim 22, wherein an underwriting broker-dealer or an affiliate thereof owns an interest in the wholesale broker-dealer.

24. The system of claim 21, wherein the allocation module allocates at least one of the wholesale fees and the expenses allocated to each of the at least a plurality of the partial owners based on the wholesale support services received by registered representatives affiliated with the respective partial owners.

25. The system of claim 21, wherein the distribution for at least a plurality of the partial owners is one of a profit for receipt by the respective partial owner and a loss to be paid by the respective partial owner to the wholesale broker-dealer.

26. The system of claim 21, comprising a reports module for generating reports comprising at least one of the determined distributions for receipt by computer systems operated by the partial owners.
